(19) United States
(12) Patent Application Publication
(10) Pub. No.: US 2022/0247136 A1
(43) Pub. Date: Aug. 4, 2022

(54) COAXIAL CABLE CONNECTOR

(71) Applicant: EZCONN CORPORATION, New Taipei City (TW)

(72) Inventor: Kai Wei Huang, New Taipei City (TW)

(21) Appl. No.: 17/582,027

(22) Filed: Jan. 24, 2022

(30) Foreign Application Priority Data
Feb. 4, 2021 (TW) 110201374
Jan. 21, 2022 (TW) 111102575

(51) Int. Cl. H01R 24/40; H01R 9/05; H01R 13/622

(52) U.S. Cl. CPC H01R 24/40; H01R 9/0521; H01R 13/622; H01R 9/0527

(57) ABSTRACT

A coaxial cable connector includes an inner sleeve, a first outer sleeve, a nut, and a second outer sleeve. The outer surface of inner sleeve is stepladder-like and the inner sleeve surrounds an axial line. The inner sleeve includes a first surface and a second surface. The head portion of the first outer sleeve surrounds the first surface of the inner sleeve. The inner flange of the nut surrounds the second surface of the inner sleeve, and the inner flange has an inclined surface arranged angularly to the axial line. The second outer sleeve is sleeved on the end portion of the first outer sleeve. When the second outer sleeve moves toward the nut axially, the inner peripheral surface of the second outer sleeve presses against the end portion of the first outer sleeve so that the first outer sleeve is compressed toward the axial line.

### RELATED APPLICATIONS

This application claims priorities to TW Application Ser. No. 110126739, filed on Feb. 4, 2021 and to TW Application Ser. No. 111102575, filed on Jan. 21, 2022, which is incorporated herein by reference in its entirety.

### TECHNICAL FIELD

The present invention is related to a coaxial cable connector, especially, related to a coaxial cable connector with good electrical connectivity.

### BACKGROUND

At present, TV reception is mainly based on cable TV. The signal of the cable TV is transmitted to the receiving TV by a coaxial cable. This coaxial cable connects to the cable TV decoders, cassette recorders/digital video discs (VCR/DVD) hard disk digital recorders, satellite receivers, video games, TV signal distribution splitters, and switch connections via the screw-on F-Type connectors.

The above-mentioned problem of poor electrical conduction will result in poor grounding of the connector body and the threaded interface connector. The reasons of poor grounding of the conventional screw-on F-Type connector may be caused via that the nut of the F-type connector did not tightly contact with inner sleeve of the F-type connector, and/or via that the inner sleeve of the F-type connector did not contact with the above-mentioned threaded surface connector of the device. That is, the poor contact condition of the F-type connector itself and the poor contact condition between the F-type connector and the threaded surface connector threaded surface connector lead to the poor grounding, and further, the performance of the electrical signal transmission becomes worse. In addition, the external force, such as pulling force, applied to the coaxial cable may cause the coaxial cable detach from the coaxial cable connector so that the signal transmission becomes unstable. Hence, the present invention provides a coaxial cable connector for the satisfactory products to solve the problems of prior art.

### SUMMARY

The purpose of the present invention is to provide a coaxial cable connector that can solve at least one of the disadvantages.

The purpose of the present invention is to provide a coaxial cable connector that can improve the stability of the configuration of the coaxial cable connector itself, especially, stability of the contact of the nut and the inner sleeve.

The purpose of the present invention is to provide a coaxial cable connector that can improve the contact between the coaxial cable connector and the device, especially, the contact interface between the coaxial cable connector and the threaded surface connector of the device.

The present invention provides a coaxial cable connector. The coaxial cable connector is suitable for connecting a connector with a threaded surface of an electronic device. The coaxial cable connector includes an inner sleeve, a first outer sleeve, a nut and a second outer sleeve. The inner sleeve surrounds an axial line. An outer surface of the inner sleeve is stepladder-like. The inner sleeve includes a first surface and a second surface. The first outer sleeve is coaxially arranged outside the inner sleeve. The first outer sleeve includes a head portion and an end portion. The head portion surrounds the first surface of the inner sleeve. The nut is sleeved on the inner sleeve and includes a threaded section and an inner flange. The threaded section connects to the threaded surface of the electronic device. The inner flange has an inclined surface arranged angularly to the axial line. The second outer sleeve is sleeved on the end portion of the first outer sleeve. An inner peripheral surface of the second outer sleeve presses against the end portion of the first outer sleeve and approaches the axial line as the second outer sleeve moves axially toward the nut.

In some embodiments, the inner peripheral surface of the second outer sleeve has a guiding inclined surface, facing the end portion of the first outer sleeve.

In some embodiments, an inner surface of the end portion of the first outer sleeve is rough.

In some embodiments, an outer peripheral surface of a rearward extending section of the inner sleeve is parallel to the axial line, and an inner surface of the end portion of the first outer sleeve has a groove.

In some embodiments, the coaxial cable connector further includes a C-shaped ring being conductive and arranged between the second surface of the inner sleeve and the inclined surface of the inner flange.

In some embodiments, the coaxial cable connector further includes a spring being conductive and including a base and at least one elastic wing, the base connected to the second surface of the inner sleeve, the elastic wing is bent outward based on the base with an angle as the spring is in a relaxed state, the elastic wing is arranged between the inner flange and the inner sleeve radially as the elastic wing is in a compressed state.

In some embodiments, the coaxial cable connector further includes a C-shaped ring being conductive and arranged between the second surface of the inner sleeve and the inclined surface of the inner flange.

In some embodiments, an upper-side width and a lower-side width of the C-shaped ring are equal cross-sectionally.

In some embodiments, the elastic wing being against an inclined surface of the inner flange of the nut, the inclined surface is inclined from a radially extending surface of the inner flange to an axially extending surface of the inner flange.

In some embodiments, a thickness of the elastic wing is ranging from 0.05 mm to 0.5 mm.

In some embodiments, the base and the elastic wing are integrated.

In some embodiments, the inner sleeve further includes an outer flange, the second surface of the inner sleeve is arranged between the outer flange and the first surface, the spring further includes a baffle portion and a connecting portion connecting to the baffle portion and the base, the spring is in a compressed state as the nut exactly connects to the connector of the electronic device, the baffle portion is arranged between the outer flange and the inner flange, and further the connecting portion is arranged between the inner flange and the inner sleeve radially.

In some embodiments, the angle of the spring is an acute angle and faces to the baffle portion as the spring relaxed.

In some embodiments, a thickness of the baffle portion is ranging from 0.05 mm to 0.5 mm.

The present invention also provides a coaxial cable connector. The coaxial cable connector is suitable for connecting a connector with a threaded surface of an electronic device. The coaxial cable connector includes an inner sleeve, a first outer sleeve, a nut and a second outer sleeve. The inner sleeve surrounds an axial line and includes a first surface, a second surface and an inclined surface. An outer surface of the inner sleeve is stepladder-like. The inclined surface arranged angularly to the axial line. The first outer sleeve is coaxially arranged outside the inner sleeve and includes a head portion and an end portion. The head portion surrounds the first surface of the inner sleeve. The nut is sleeved on the inner sleeve. The nut includes a threaded section and an inner flange. The threaded section connects to the threaded surface of the electronic device. The inner flange surrounds the second surface of the inner sleeve. The second outer sleeve is sleeved on the end portion of the first outer sleeve. An inner peripheral surface of the second outer sleeve presses against the end portion of the first outer sleeve approaches the axial line as the second outer sleeve axially moves toward the nut.

In some embodiments, an outer peripheral surface of a rearward extending section of the inner sleeve is parallel to the axial line, and an inner surface of the end portion of the first outer sleeve has a groove.

In some embodiments, an inner surface of the end portion of the first outer sleeve is rough.

In some embodiments, the coaxial cable connector further includes a C-shaped ring being conductive and surroundingly connected to the inclined surface of the inner sleeve, wherein the C-shaped ring is pushed via a radially extending surface of the inner flange to move along the inclined surface.

In some embodiments, a cross-section shape of the conductive C-shaped ring can be selected from one of rectangle, circle, ellipse and polygon type.

In some embodiments, the coaxial cable connector further includes a spring including a base and at least one elastic wing, the base connected to the second surface of the inner sleeve, the elastic wing is further lying against the inclined surface of the inner sleeve.

The present invention provides a coaxial cable connector. The coaxial cable connector is suitable for connecting a connector with a threaded surface of an electronic device. The coaxial cable connector includes an inner sleeve, a first outer sleeve, a nut, a spring and a second outer sleeve. The inner sleeve surrounds an axial line. An outer surface of the inner sleeve is stepladder-like. The inner sleeve includes a first surface and a second surface. The first outer sleeve is coaxially arranged outside the inner sleeve. The first outer sleeve includes a head portion and an end portion. The head portion surrounds the first surface of the inner sleeve. The end portion has an end surface perpendicular to the axial line and a groove on an inner surface thereof. The nut is sleeved on the inner sleeve and includes a threaded section and an inner flange. The threaded section connects to the threaded surface of the electronic device. The inner flange has an inclined surface arranged angularly to the axial line. The spring is conductive and includes a base and a single elastic wing, the base surrounds the part of the second surface of the inner sleeve, and the single elastic wing is suitable for lying against the inclined surface of the nut. The second outer sleeve is sleeved on the end portion of the first outer sleeve. An inner peripheral surface of the second outer sleeve presses against the end portion of the first outer sleeve and approaches the axial line as the second outer sleeve moves axially toward the nut.

In some embodiments, the spring further includes a baffle porting and two connecting portions, the connecting portions connect the baffle portion and the base, the single elastic wing is located in the middle of the connecting portions, and the baffle portion is annular. When the spring is in a relaxed state, a first angle between the single elastic wing and the axial line is greater than a second angle between the inclined surface of the nut and the axial line.

In some embodiments, the spring further includes a protrusion portion formed on the single elastic wing, the protrusion portion is used for contacting the inclined surface of the nut, and a thickness of the protrusion portion is ranging from 0.1 mm to 0.2 mm.

In some embodiments, a shape of the protrusion portion of the spring can be selected from one of circle, rectangle, square, diamond, trapezoid, ellipse, cross and polygon.

In some embodiments, the single elastic wing of the spring is in a bent shape, the single elastic wing has a first extension and a second extension, and a ridge is formed at the junction of the first extension and the second extension, the ridge is used for contacting the inclined surface of the nut.

In some embodiments, the single elastic wing of the spring is in an arc shape.

The present invention also provides a coaxial cable connector. The coaxial cable connector is suitable for connecting a connector with a threaded surface of an electronic device. The coaxial cable connector includes an inner sleeve, a first outer sleeve, a nut, a spring and a second outer sleeve. The inner sleeve surrounds an axial line. An outer surface of the inner sleeve is stepladder-like. The inner sleeve includes a first surface, a second surface and an inclined surface. The inclined surface arranged angularly to the axial line. The first outer sleeve is coaxially arranged outside the inner sleeve and includes a head portion and an end portion. The head portion surrounds the first surface of the inner sleeve. The end portion has an end surface perpendicular to the axial line and a groove on an inner surface thereof. The nut is sleeved on the inner sleeve. The nut includes a threaded section and an inner flange. The threaded section connects to the threaded surface of the electronic device. The inner flange surrounds the second surface of the inner sleeve. The inner flange has an inclined surface arranged angularly to the axial line. The spring is conductive and includes a base and a single elastic wing, the base is annular and surrounds the second surface of the inner sleeve, and the single elastic wing is suitable for lying against the inclined surface of the inner sleeve. The second outer sleeve is sleeved on the end portion of the first outer sleeve. An inner peripheral surface of the second outer sleeve presses against the end portion of the first outer sleeve approaches the axial line as the second outer sleeve axially moves toward the nut.

In some embodiments, the spring further includes a protrusion portion formed on the single elastic wing, the protrusion portion is used for contacting the inclined surface of the inner sleeve, and a thickness of the protrusion portion is ranging from 0.1 mm to 0.2 mm.

In some embodiments, the single elastic wing of the spring is in a bent shape, the single elastic wing has a first extension and a second extension, and a ridge is formed at the junction of the first extension and the second extension, the ridge is used for contacting the inclined surface of the inner sleeve.

### BRIEF DESCRIPTION OF THE DRAWINGS

Unless specified otherwise, the accompanying drawings illustrate aspects of the innovative subject matter described herein. Referring to the drawings, wherein like reference numerals indicate similar parts throughout the several views, several examples of coaxial cable connector incorporating aspects of the presently disclosed principles are illustrated by way of example, and not by way of limitation.

FIG. 1 illustrates a cross-sectional view of a first embodiment of a coaxial cable connector of the present invention.

FIG. 2 illustrates a sectional view of a coaxial cable of the present invention.

FIG. 3 illustrates a stereogram of the spring of the first embodiment.

FIG. 4 illustrates a left-side view of the spring of the first embodiment.

FIG. 5 illustrates a front-side view of the spring of the first embodiment.

FIG. 6 illustrates a cross-sectional view of the coaxial cable connector having the coaxial cable illustrated in the first embodiment, wherein a first outer sleeve of the first embodiment has not been pressed and deformed by a second outer sleeve.

FIG. 7 illustrates a cross-sectional view of the coaxial cable connector having the coaxial cable illustrated in the first embodiment, wherein the end portion of the first outer sleeve of the first embodiment has been compressed and moves toward to the coaxial cable.

FIG. 8 and FIG. 9 illustrate a schematic diagram of the flowchart of connecting the coaxial cable connector to the connector of the electronic device according to the first embodiment.

FIG. 10, FIG. 11 and FIG. 12 illustrate individually a stereogram, a left-side view and a cross-sectional view of another spring applied to the coaxial cable connector of the first embodiment.

FIG. 13 illustrates a schematic diagram of an electronic device having the coaxial cable connector combined with the spring illustrated in FIG. 10.

FIG. 14 illustrates a cross-sectional view of the coaxial cable connector combined with a C-shaped ring according to the first embodiment.

FIG. 15 illustrates a cross-sectional view of a second embodiment of a coaxial cable connector of the present invention.

FIG. 16 illustrates a stereogram of the spring of the second embodiment, the spring has a single elastic wing.

FIG. 17 illustrates a side view of the spring of the second embodiment.

FIG. 18 illustrates a bottom view of the spring of the second embodiment.

FIG. 19 illustrates a side view of an alternative spring of the second embodiment.

FIG. 20 illustrates a stereogram view of another alternative spring of the second embodiment.

FIG. 21 illustrates a cross-sectional view of a third embodiment of a coaxial cable connector of the present invention.

FIG. 22 illustrates a cross-sectional view of the coaxial cable connector having a spring according to the third embodiment.

FIG. 23 illustrates a cross-sectional view of a fourth embodiment of a coaxial cable connector of the present invention.

FIG. 24 illustrates a cross-sectional view of the spring of the fourth embodiment, the spring has a single elastic wing.

FIG. 25 illustrates a side view of an alternative spring of the fourth embodiment, a single elastic wing of the alternative spring has a ridge.

FIG. 26 illustrates a side view of another alternative spring of the fourth embodiment, a single elastic wing of another alternative spring is in an arc shape.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

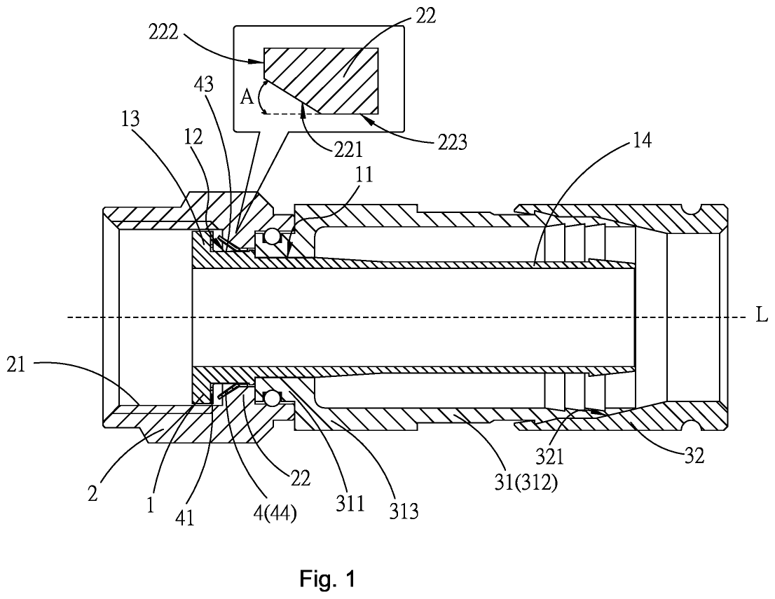

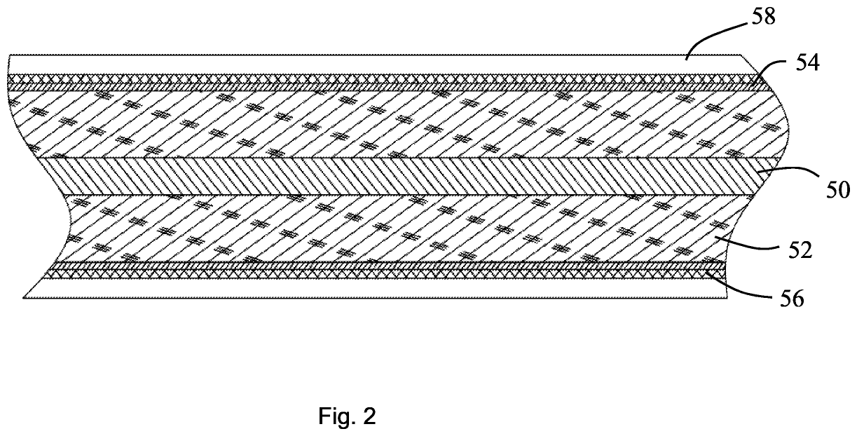

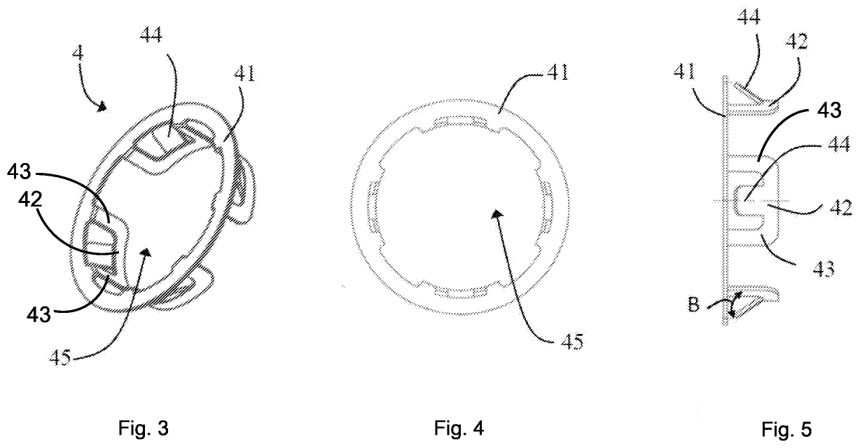

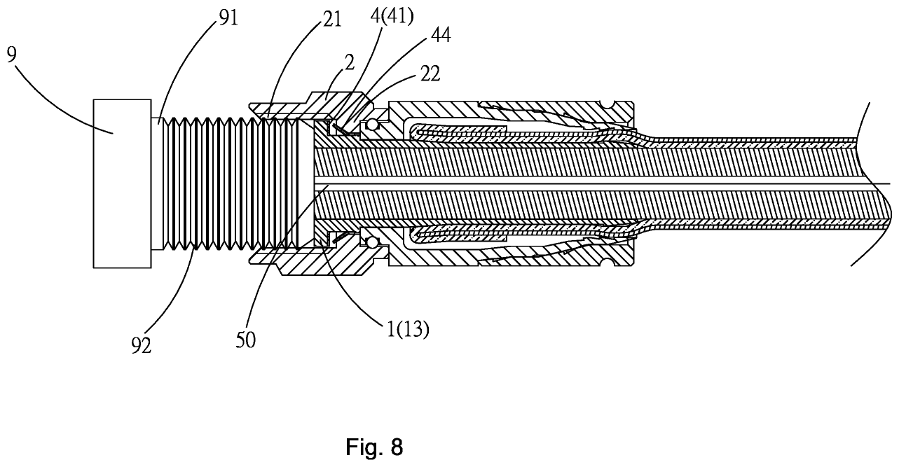

FIG. 1 illustrates a cross-sectional view of a first embodiment of a coaxial cable connector of the present invention. FIG. 2 illustrates a sectional view of a coaxial cable of the present invention. FIG. 3 illustrates a stereogram of the spring of the first embodiment. Referring to FIGS. 1 to 3, a first embodiment of coaxial cable connector of the present invention is illustrated. In this embodiment, the coaxial cable connector is suitable for connecting a connector 91 with a threaded surface 92 of an electronic device 9 (as illustrated in FIG. 8). The coaxial cable connector comprises an inner sleeve 1, a nut 2, a first outer sleeve 31, a second outer sleeve 32, and a spring 4, wherein a coaxial cable is wrapped coaxially in the inner sleeve 1, the first outer sleeve 31, and the second outer sleeve 32. The inner sleeve 1, the first outer sleeve 31, and the spring 4 are conductive. The material can be metal materials, such as copper, iron, silver, nickel, gold, copper-gold alloy, copper-tin alloy, copper-nickel alloy. Also, the material can be selected from polymer, non-metallic conductors with good conductivity and the combination of the above-mentioned materials. In some cases, the surfaces of the inner sleeve 1, the first outer sleeve 31, and the spring 4 can be formed at least an anti-rust metal layer via electroplating, vapor deposition and any other proper method. The material of the anti-rust metal layer includes a copper, iron, silver, nickel, gold, copper-gold alloy, copper-tin alloy, copper-nickel alloy, other polymer, non-metallic conductors with good conductivity and so on.

The cross-sectional view of the coaxial cable is shown in FIG. 2. The coaxial cable includes a metal wire 50 wrapped with an insulating layer 52. The insulating layer 52 is wrapped with a metal film 54. The metal film 54 is wrapped with a braid layer 56. The braid layer 56 is wrapped with a plastic layer 58. The material of the metal wire 50 includes copper, iron, silver, nickel, gold, copper-gold alloy, copper-tin alloy, copper-nickel alloy or other polymer, non-metallic conductors with good conductivity and so on. The metal film 54 includes a metal layer containing aluminum, a metal layer containing copper and a conductive layer containing conductive materials, such as an aluminum foil coating layer or a copper foil coating layer. The metal film 54 is electrical shielded so that the interference effect can be decreased. The form of the braid layer 56 includes different covering forms such as two-layer weaving (Standard), three-layer weaving (Tri-shield) and four-layer weaving (Quad).

In the present invention, the inner sleeve 1 surrounds an axial line L, and the outer surface of the inner sleeve 1 is stepladder-like. The inner sleeve 1 includes a first surface 11, a second surface 12, an outer flange 13, and a rear extension section 14. The second surface 12 of the inner sleeve 1 is arranged between the outer flange 13 and the first surface 11. The outer diameter and thickness of the rear extension section 14 are smaller than the outer diameter and thickness of the first surface 11.

The nut 2 is sleeved on the inner sleeve 1. The nut 2 includes an internal threaded section 21 and an inner flange 22. The threaded section 21 is used to connect to the threaded surface 92 of the electronic device 9 (as illustrated FIG. 8). The inner flange 22 surrounds the second surface 12 of the inner sleeve 1. The inner flange 22 includes a radially extending surface 222, an axially extending surface 223, and an inclined surface 221, wherein the inclined surface 221 is arranged angularly to the axial line L. The inclined surface 221 is inclined from the radially extending surface 222 to the axially extending surface 223. An angle A between the inclined surface 221 and the axially extending surface 223 can be ranging from 15 degrees to 60 degrees, ranging from 10 degrees to 30 degrees or ranging from 20 degrees to 45 degrees. The outer shape of the nut 2 can be any type of nut, such as hexagon nut, square nut, ring nut, wing nut and so on. The coaxial cable connector can be installed to the electronic device 9 via a wrench or other tools.

The first outer sleeve 31 is coaxially arranged outside the inner sleeve 1. The first outer sleeve 31 includes a head portion 311, an end portion 312, and a shoulder 313 connecting to the head portion 311 and the end portion 312. The head portion 311 of the first outer sleeve 31 surrounds the first surface 11 of the inner sleeve 1. The outer diameter and thickness of the end portion 312 are smaller than the outer diameter and thickness of the head portion 311. In other embodiments, the outer diameter and thickness of the end portion 312 could be greater than or equal to the outer diameter and thickness of the head portion 311. The end portion 312 of the first outer sleeve 31 and the rear end extension 14 of the inner sleeve 1 are arranged concentrically, wherein a ring-shaped hollow is sandwiched between the end portion 312 and the rear end extension 14.

The second outer sleeve 32 is sleeved on the end portion 312 of the first outer sleeve 31. The inner peripheral surface of the second outer sleeve 32 is a guiding inclined surface 321. The guiding inclined surface 321 faces to the end portion 312 of the first outer sleeve 31 and is arranged angularly to the axial line L. Preferably, the guiding inclined surface 321 matches the shape of an outer surface of the end portion 312 of the first outer sleeve 31.

FIG. 1 illustrates a cross-sectional view of a first embodiment of a coaxial cable connector of the present invention. FIG. 3 illustrates a stereogram of the spring of the first embodiment. FIG. 4 illustrates a left-side view of the spring of the first embodiment. FIG. 5 illustrates a front-side view of the spring of the first embodiment.

Referring to FIGS. 1, 3, 4 and 5, the spring 4 is sleeved on the second surface 12 of the inner sleeve 1. In this embodiment, the spring 4 includes a baffle portion 41, a plurality of base sections 42, a plurality of connecting portions 43, and a plurality of elastic wing 44. The baffle portion 41 has a through hole 45. The configuration of the baffle portion 41 can be a ring-like structure or a structure with a cavity having a radian ranging from 10 degrees to 30 degrees, ranging from 20 degrees to 45 degrees, ranging from 60 degrees to 150 degrees, or ranging from 60 degrees to 120 degrees. The diameter of the baffle portion 41 must be limited to the range where the spring 4 can be arranged tightly to the edge of the second surface 12 of the inner sleeve 1. The base 42 is surrounded to the second surface 12 of the inner sleeve 1. The connecting portions 43 are arranged at intervals along the circumference. One end of each connecting portion 43 is connected to the baffle portion 41, and the other end is connected to the corresponding base 42. The elastic wings 44 are respectively connected to the base 42, wherein each elastic wing 44 is pressed against the inclined surface 221 of the inner flange 22 of the nut 2. Preferably, the baffle portion 41, the base 42, the connecting portion 43, and the elastic wing 44 are integrated.

In the present invention, the spring 4 is in a relaxed state before assembled with other components. Each elastic wing 44 is bent outward based on the corresponding base 42 with a first angle B. The first angle B is an acute angle ranging from 10 degrees to 20 degrees, ranging from 15 degrees to 60 degrees, ranging from 20 degrees to 45 degrees, or ranging from 30 degrees to 75 degrees, and an opening of the first angle B faces to the baffle portion 41. As the spring 4 is arranged in the inner sleeve 1, the elastic wing 44 presses against the inclined surface 221 of the inner flange 22 of the nut 2, and the connecting portion 43 of the spring 4 is tightly contact to the peripheral edge of the second surface 12. Thus, the assembly of the spring 4 and the inner sleeve 1 can be stable and fastened. Furthermore, the thicknesses of the baffle portion 41, the connecting portion 43, and the elastic wing 44 of the spring 4 can be ranging from 0.05 mm to 0.5 mm or ranging from 0.03 mm to 1 mm selectively. In addition, the shape of the elastic wing 44 includes square, triangle, semicircle and a polygon; the feature of the surface of the elastic wing 44 can be smooth, rough, granular and the combination above.

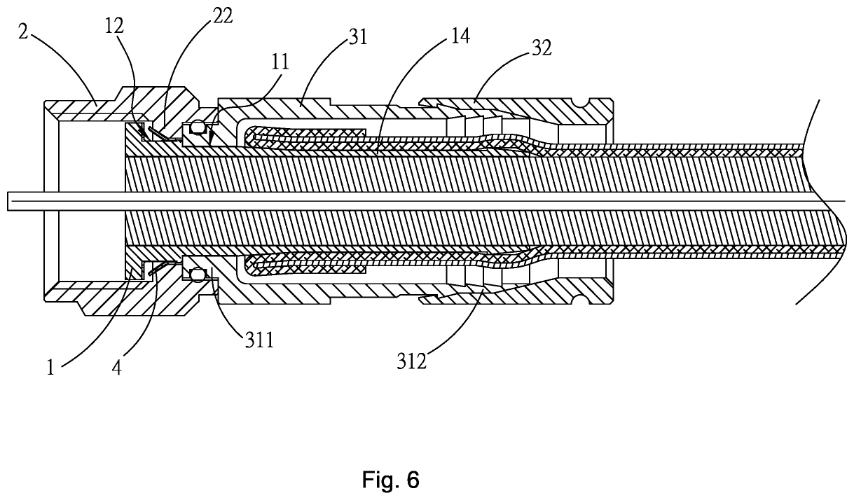

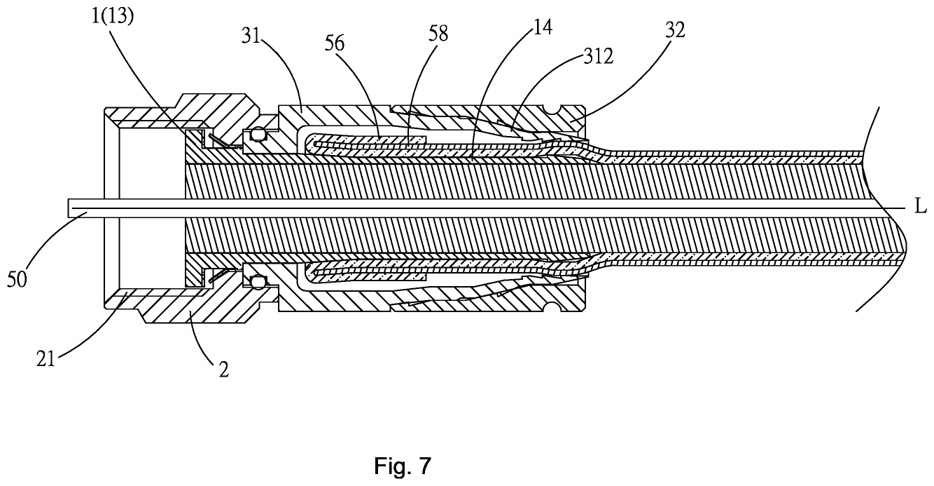

FIG. 1 illustrates a cross-sectional view of a first embodiment of a coaxial cable connector of the present invention. FIG. 5 illustrates a front-side view of the spring of the first embodiment. FIG. 6 illustrates a cross-sectional view of the coaxial cable connector having the coaxial cable illustrated in the first embodiment, wherein a first outer sleeve of the first embodiment has not been pressed and deformed by a second outer sleeve. FIG. 7 illustrates a cross-sectional view of the coaxial cable connector having the coaxial cable illustrated in the first embodiment, wherein the end portion of the first outer sleeve of the first embodiment has been compressed and moves toward to the coaxial cable. Referring to FIGS. 1, 5, 6 and 7 in order, one of the procedures for assembling the coaxial cable connector is illustrated. At first, thread the inner sleeve 1 from the end of the rear end extension 14 through the through hole 45 of the spring 4 so that the through hole 45 of the spring 4 can be tightly fit to the second surface 12 of the inner sleeve 1. Then, thread the inner sleeve 1 having the spring 4 from the end of the rear end extension 14 through the nut 2 so that the inner flange 22 of the nut 2 surrounds the second surface 12 of the inner sleeve 1 and the surface of the spring 4. Then, tightly thread the inner sleeve 1 having the spring 4 from the end of the rear end extension 14 through the first outer sleeve 31. The first surface 11 of the inner sleeve 1 is exactly assembled to the head portion 311 of the first outer sleeve 31. At last, thread the end portion 312 of the first outer sleeve 31 through the second outer sleeve 32.

As installing the coaxial cable to the coaxial cable connector, the braid layer 56 and the plastic jacket 58 of the coaxial cable will be compressed and squeezed into the groove arranged between the rear end extension 14 of the inner sleeve 1 and the end portion 312 of the first outer sleeve 31. A part of the braid layer 56 will be turned outwards and cover a part of the plastic jacket 58. The metal wire 50, insulation layer 52, and metal film 54 of the coaxial cable are threaded through the outer flange 13 of the inner sleeve 1, wherein the metal wire 50 extends into the grooves of the threaded section 21 of the nut 2. In order to avoid the situation that the coaxial cable loosen from the connector due to the external forces (ex. pulling force), the inner peripheral surface of the second outer sleeve 32 tightly presses against the end portion 312 of the first outer sleeve 31 and gradually approaches to the axial line L as the second outer sleeve 32 axially moves toward the nut 2. Hence, the end portion 312 of the first outer sleeve 31 can be tightly assemble to the coaxial cable since the radial component force acts on the end portion 312 with elasticity, as shown in FIG. 7.

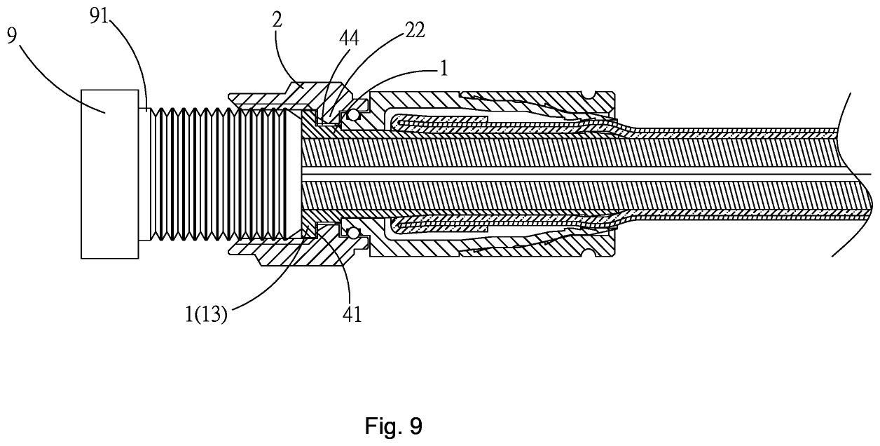

FIG. 8 and FIG. 9 illustrate a schematic diagram of the flowchart of connecting the coaxial cable connector to the connector of the electronic device according to the first embodiment. Referring to FIGS. 8 and 9, a schematic diagram of the flowchart of connecting the coaxial cable connector to the connector of the electronic device is illustrated. In the beginning, align the connector with the coaxial cable to the connector 91 with the threaded surface 92 of the electronic device 9, and thread the metal wire 50 arranged in the center of the coaxial cable through the connector 91 with the threaded surface 92. Then, screw the nut 2 to make the outer flange 13 of the inner sleeve 1 of the coaxial cable connector gradually approach the connector 91. During screwing the nut 2, the inner flange 22 of the nut 2 gradually approaches the baffle portion 41 of the spring 4 until mutually contacted. Meanwhile, the inner flange 22 of the nut 2 also presses the elastic wing 44 of the spring 4 so that the angle of the elastic wing 44 is restricted. During screwing the nut 2, the elastic wing 44 of the spring 4 are compressed (or constrained) from the relaxed state (as shown in FIG. 8) to the compressed state (as shown in FIG. 9). Both the coaxial cable connector and the connector 91 of the electronic device 9 are tightly and fixedly locked as the nut 2 is tightly assembled to the connector 91 of the electronic device 9. At this time, the elastic wing 44 is radially arranged between the inner flange 22 of the nut 2 and the second surface 12 of the inner sleeve 1. The inner flange 22 of the nut 2 is pressed against the baffle portion 41 of the spring 4. Because the reasons of that the baffle portion 41 to tightly contact the outer flange 13 of the inner sleeve 1 is tightly pressed via the inner flange 22 of the nut 2, that the baffle portion 41 is arranged between the outer flange 13 and the inner flange 22, and that the elastic wing 44 is elastic, the spring 4 can be tightly assembled to the surface of the inner sleeve 1. The elastic wing 44 and the connecting portion 43 are radially arranged between the inner flange 22 and the inner sleeve 1. The excellent contact interfaces among baffle portion 41, the elastic wing 44, and the connecting portion 43 can be implemented via the inner flange 22 of the nut 2. Thus, the performances of the electrical signal transmission as well as the electrical connection for grounding can both be greatly improved.

It is worth mentioning that purpose and effect of the coaxial cable connector can also be achieved if the spring 4 has one elastic wing 44, one connecting portion 43, and one base 42.

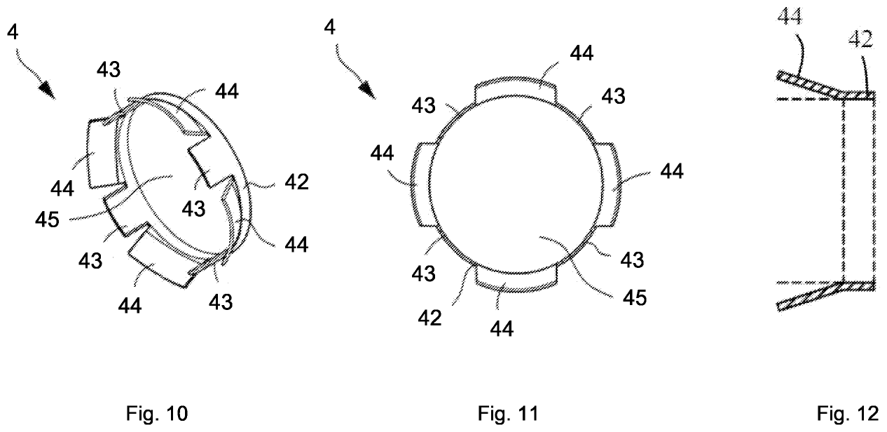

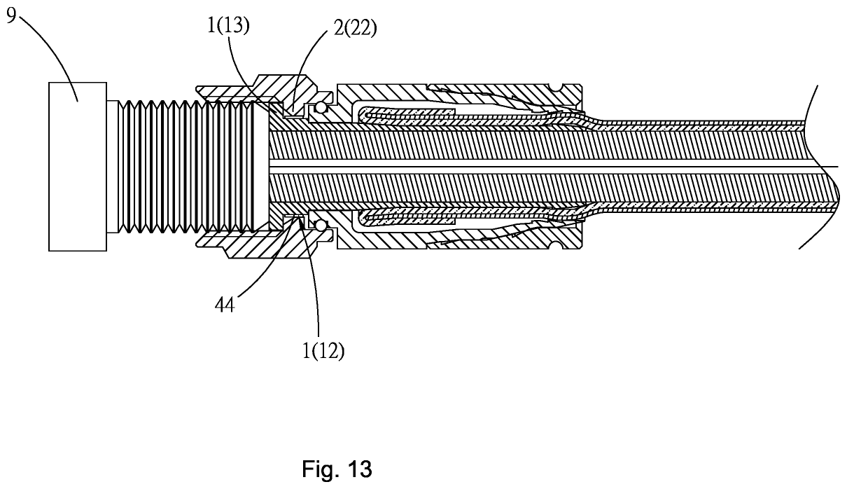

FIG. 10, FIG. 11 and FIG. 12 illustrate individually a stereogram, a left-side view and a cross-sectional view of another spring applied to the coaxial cable connector of the first embodiment. FIG. 13 illustrates a schematic diagram of an electronic device having the coaxial cable connector combined with the spring illustrated in FIG. 10.

Referring to FIGS. 10, 11, 12 and 13, another spring applied to the coaxial cable connector of the first embodiment is illustrated. The spring 4 has only one base 42, a plurality of connecting portion 43, and a plurality of elastic wing 44. The elastic wing 44, the base 42, and the connecting portion 43 are integrated. The connecting portions 43 and the elastic wings 44 are arranged at intervals along the circumference of the base 42. As the coaxial cable connector is assembled to the electronic device 9, the inner flange 22 of the nut 2 is in contacted with the outer flange 13 of the inner sleeve 1, and the elastic wing 44 is radially arranged between the flange 22 of the nut 2 and the second surface 12 of the inner sleeve 1. The nut 2 is tightly assembled to the inner sleeve 1 via the elastic force of the elastic wing 44. Thus, the performances of the electrical signal transmission as well as the electrical connection for grounding can both be greatly improved.

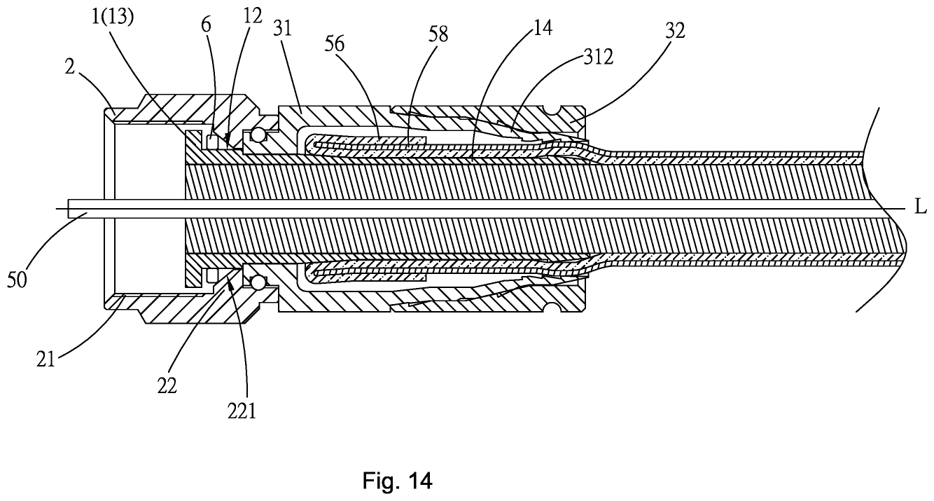

FIG. 14 illustrates a cross-sectional view of the coaxial cable connector combined with a C-shaped ring according to the first embodiment. Referring to FIG. 14, a C-shaped ring 6 can be exerted to replace the spring. The C-shaped ring 6 is arranged between the second surface 12 of the inner sleeve 1 and the inclined surface 221 of the inner flange 22. The cross-section of the C-shaped ring 6 is a rectangle of equal width up and down in this embodiment. In other words, an upper-side width and a lower-side width of the C-shaped ring are equal cross-sectionally. For instance, the shape of cross-section of the C-shaped ring 6 illustrated is a rectangle with equal upper-side width and lower-side width. In other cases, the shape of cross-section of the C-shaped ring 6 can be a parallelogram, circle, ellipse, or polygon with equal upper-side width and lower-side width. The C-shaped ring 6 is conductive, and the material of C-shaped ring 6 includes copper, iron, silver, nickel, tin, gold, copper-gold alloy, copper-tin alloy, copper-nickel alloy, brass, brass alloy, phosphor bronze, beryllium copper, aluminum, aluminum alloys, zinc alloys, steel alloys, polymers with good conductivity (such as conductive plastics), non-metallic conductors and so on. The surface of the C-shaped ring 6 can be treated via electroplating, electroless electroplating, or covering with a layer of anti-rust metal. The material of the anti-rust metal includes a metal material such as copper, iron, silver, nickel, tin, gold and so on. In this embodiment, the C-shaped ring 6 moves along the inclined surface 221 of the inner flange 22 during the inner flange 22 of the nut 2 axially moves toward the outer flange 13 of the inner sleeve 1. The deformation of the C-shaped ring 6 occurred in a confined and narrow space makes the contact between the nut 2 and the inner sleeve 1 become much tighter. This stable assembly of the nut 2 and the inner sleeve 1 can guarantee that the electrical connection of the coaxial cable connector is reliable during operation. Meanwhile, the performances of the electrical signal transmission as well as the electrical connection for grounding can both be greatly improved.

It is noted that in some embodiments, both the C-shaped ring and the spring can be exerted to the coaxial cable connector. For example, the base of the spring can be connected to the second surface of the inner sleeve, and the elastic wing of the spring and a part of the C-shaped ring are arranged between the second surface of the inner sleeve and the inclined surface of the inner flange. The inclined surface of the inner flange tightly contacts to the elastic wing and the C-shaped ring as the inner flange moves axially toward the outer flange. The good electrical contact can be achieved.

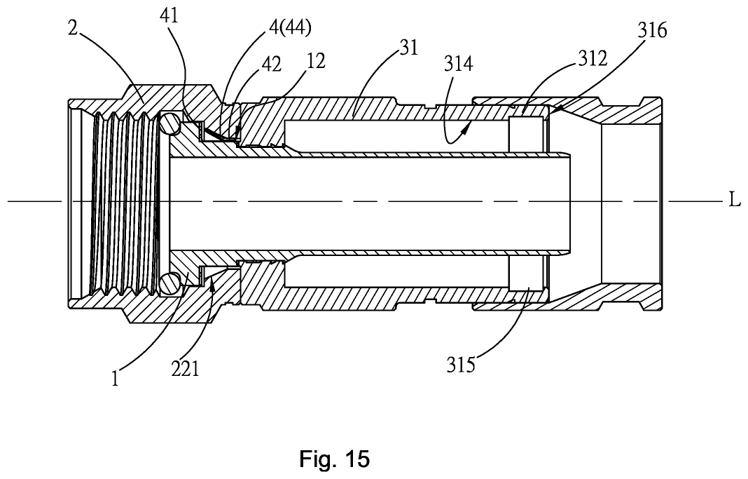

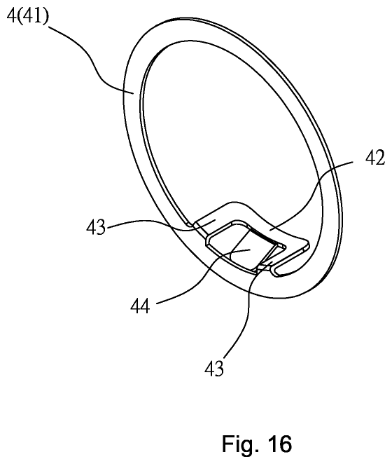

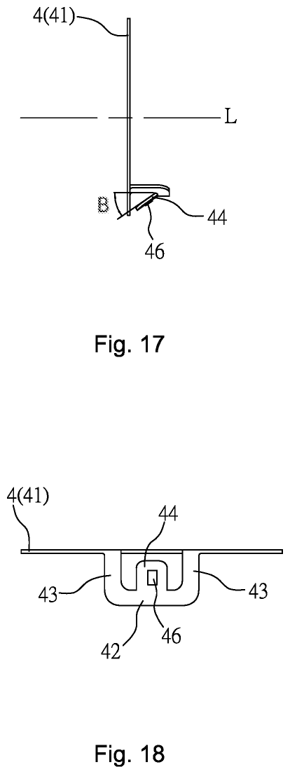

FIG. 15 illustrates a cross-sectional view of a second embodiment of a coaxial cable connector of the present invention. FIG. 16 illustrates a stereogram of the spring of the second embodiment, the spring has a single elastic wing. FIG. 17 illustrates a side view of the spring of the second embodiment. FIG. 18 illustrates a bottom view of the spring of the second embodiment. Referring to FIGS. 15 to 18, a second embodiment of the coaxial cable connector is illustrated, wherein most of features are similar to the first embodiment. Some different is disclosed as below:

The end portion 312 of the first outer sleeve 31 has an end surface 316 perpendicular to the axial line L and a groove 315 located on the inner surface 314 thereof. The spring 4 includes a baffle portion 41 surrounding the axis line L, a base 42, two connecting portions 43, and a single elastic wing 44. The base 42 surrounds a part of the second surface 12 of the inner sleeve 1. The number of the elastic wings 44 is only one. The single elastic wing 44 is connected to the base 42 and is located in the middle of the two connecting parts 43. The two connecting portions 43 connect the baffle portion 41 and the base 42, and the baffle portion 41 is annular. When the spring 4 is in a relaxed state, a first angle B between the single elastic wing 44 and the axial line L is greater than a second angle between the inclined surface 221 of the nut 2 and the axial line L. For example, the first angle B can be between 45 degrees and 65 degrees, and the second angle is equal to the angle A in FIG. 1.

In some embodiments, the spring 4 includes a protrusion portion 46 formed on the single elastic wing 44, and the protrusion portion 46 is used to contact the inclined surface 221 of the nut. Preferably, a thickness of the protrusion portion 46 is ranging from 0.1 mm to 0.2 mm. In addition, a shape of the protrusion portion 46 can be one of a circle, a rectangle, a square, a diamond, a trapezoid, an ellipse, a cross, or a polygon.

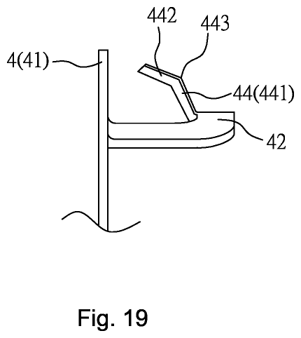

In some embodiments, the single elastic wing 44 of the spring 4 is not flat, for example, it can be bent. Referring to FIG. 19, the single elastic wing 44 of the spring 4 has a first extension 441 and a second extension 442. The first extension 441 extends outward from the base 42. A ridge 443 is formed at the junction of the first extension 441 and the second extension 442, and the ridge 443 is used to contact the inclined surface 221 of the nut 2. Or, when the single elastic wing 44 of the spring 4 is in an arc shape, the center of curvature of the single elastic wing 44 may be at the same side or a different side with the inclined surface 221 of the nut 2.

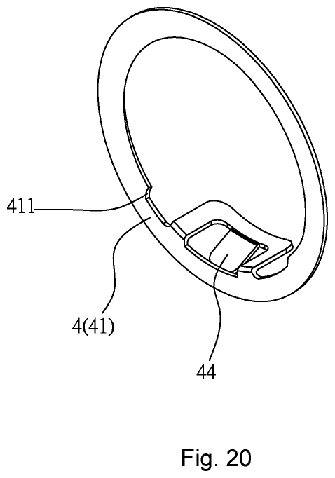

FIG. 20 illustrates a stereogram view of another alternative spring of the second embodiment. Referring to FIG. 20, in some embodiments, the spring 4 further includes a counterweight portion 411 forming on the inner peripheral surface of the baffle portion 41, and the counterweight portion 411 is correspondingly disposed on the opposite side of the single elastic wing 44, which allows the center of gravity of the spring 4 with only the single elastic wing 44 to be balanced on the axis during assembly, so as to avoid the spring 4 from being stuck and deformed between the nut 2 and inner sleeve 1 due to the inability to support the force evenly.

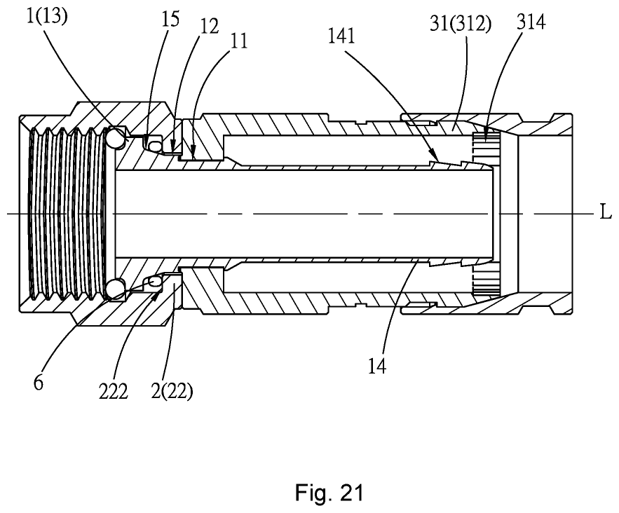

FIG. 21 illustrates a cross-sectional view of a third embodiment of a coaxial cable connector of the present invention. Referring to FIG. 21, a third embodiment of the coaxial cable connector is illustrated, wherein most of features are similar to the first embodiment. Some different is disclosed as below:

The inner sleeve 1 further includes an inclined surface 15. The second surface 12 of the inner sleeve 1 is arranged between the first surface 11 and the inclined surface 15, wherein the inclined surface 15 is arranged angularly to the axial line L. In this embodiment, a C-shaped ring 6 is used to replace the spring. The a C-shaped ring 6 surrounds the inclined surface 15 of the inner sleeve 1. During the assembly process, the radially extending surface 222 of the inner flange 22 contacts to the C-shaped ring 6 and further presses against the C-shaped ring 6. The C-shaped ring 6 moves along the inclined plane 15 as the inner flange 22 of the nut 2 axially moves toward the outer flange 13 of the inner sleeve 1. This stable assembly of the nut 2 and the inner sleeve 1 can guarantee that the electrical connection of the coaxial cable connector is reliable during operation. Meanwhile, the electrical connection for grounding can improve the performance of the electrical signal transmission. In addition, the feature of the outer peripheral surface 141 of the rearward extending section 14 of the inner sleeve 1 is jagged, while the feature of the inner surface 314 of the end portion 312 of the first outer sleeve 31 is rough. For example, these features can be knurled interference surfaces so that the tensile strength between the coaxial cable and the coaxial cable connector can be improved.

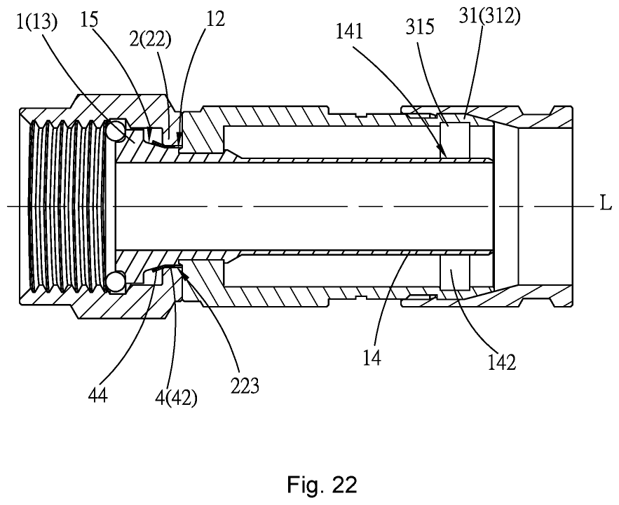

FIG. 22 illustrates a cross-sectional view of the coaxial cable connector having a spring according to the third embodiment. Referring to FIG. 22, in the coaxial cable connector of this embodiment, a spring 4 is exerted to replace the C-shaped ring. The base 42 of the spring 4 surrounds the second surface 12 of the inner sleeve 1, and the elastic wing 44 is bent at an angle outward based on the base 42. The axially extending surface 223 of the inner flange 22 contacts the base 42 of the spring 4 and further presses against the spring 4 as the inner flange 22 of the nut 2 axially moves toward the outer flange 13 of the inner sleeve 1. The elastic wing 44 is adjacent to the inclined surface 15 of the inner sleeve 1. The nut 2, the spring 4, and the inner sleeve 1 are tightly and fixedly assemble together to provide a good electrical connection for grounding.

In order to make the part of the coaxial cable (braid layer and plastic jacket) can be easily filled into the gap 142 between the rearward end extending section 14 and the end portion 312 of the first outer sleeve 31, the outer peripheral surface 141 of the rearward end extending section 14 of the inner sleeve 1 is parallel to the axial line L. Preferably, the inner surface of the end portion 312 of the first outer sleeve 31 has a groove 315. The groove 315 can be used for accommodating the part of the coaxial cable (braid layer and plastic jacket) that has been squeezed and deformed. Thus, the tensile strength between the end portion 312 of the first outer sleeve 31 and the coaxial cable can be greatly increased because of the compressed and deformed part of the coaxial cable accommodated inside the groove 315.

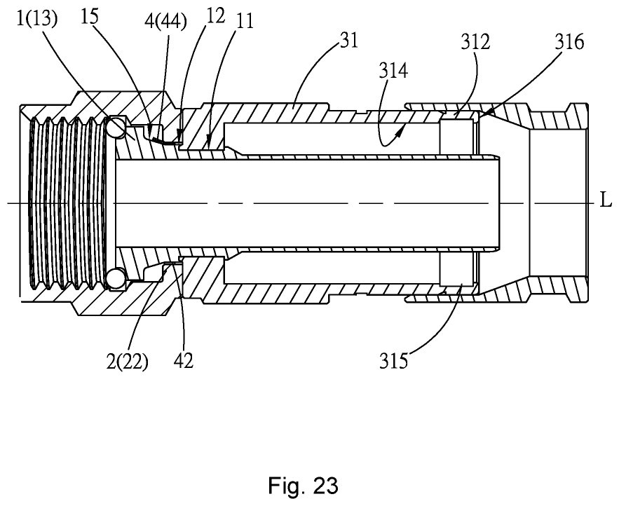

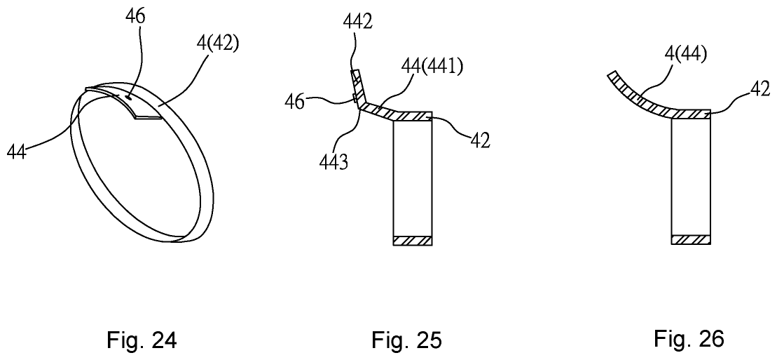

FIG. 23 illustrates a cross-sectional view of a fourth embodiment of a coaxial cable connector of the present invention. FIG. 24 illustrates a cross-sectional view of the spring of the fourth embodiment, the spring has a single elastic wing. Referring to FIGS. 22 to 23, a fourth embodiment of the coaxial cable connector is illustrated, wherein most of features are similar to the first embodiment. Some different is disclosed as below:

The inner sleeve 1 further includes an inclined surface 15. The second surface 12 of the inner sleeve 1 is arranged between the first surface 11 and the inclined surface 15, wherein the inclined surface 15 is arranged angularly to the axial line L. The end portion 312 of the first outer sleeve 31 has an end surface 316 perpendicular to the axial line L and a groove 315 located on the inner surface 314 thereof. The spring 4 includes a base 42, a single elastic wing 44 and a protrusion portion 46. The base 42 is annular and surrounds the second surface 12 of the inner sleeve 1. The number of the elastic wings 44 is only one. The single elastic wing 44 abuts on the inclined surface 15 of the inner sleeve 1. The protrusion portion 46 protrudes outward from the surface of the single elastic wing 44 and is used to contact the inclined surface 15 of the inner sleeve 1. Preferably, a thickness of the protrusion portion 46 is ranging from 0.1 mm to 0.2 mm. The shape of the protrusion portion 46 can be any shape.

FIG. 25 illustrates a side view of an alternative spring of the fourth embodiment, a single elastic wing of the alternative spring has a ridge. FIG. 26 illustrates a side view of another alternative spring of the fourth embodiment, a single elastic wing of another alternative spring is in an arc shape. Referring to FIGS. 24 to 25, in some embodiments, the single elastic wing 44 of the spring 4 has a first extension 441 and a second extension 442. A ridge 443 is formed at the junction of the first extension 441 and the second extension 442, and the ridge 443 is used to contact the inclined surface 15 of the inner sleeve 1. Or as shown in FIG. 26, when the single elastic wing 44 of the spring 4 is in an arc shape, the center of curvature of the single elastic wing 44 is on a different side from the inclined surface 15 of the inner sleeve 1.

In summary, at least one of the spring and the C-shaped ring can be exerted and arranged between the nut and the inner sleeve in the front end of the coaxial cable connector of this invention, to ensure the coaxial cable connector can have good electrical properties. In the rear end of the coaxial cable connector, the end portion of the first outer sleeve is compressed toward the axial line via the second outer sleeve pressing against the first outer sleeve. Hence, the tensile strength between the coaxial cable connector and the coaxial cable can be increased to prevent the coaxial cable from detaching from the coaxial cable connector.

The presently disclosed inventive concepts are not intended to be limited to the embodiments shown herein, but are to be accorded their full scope consistent with the principles underlying the disclosed concepts herein. Directions and references to an element, such as “up,” “down,”, “upper,” “lower,” “horizontal,” “vertical,” “left,” “right,” and the like, do not imply absolute relationships, positions, and/or orientations. Terms of an element, such as “first” and “second” are not literal, but, distinguishing terms. As used herein, terms “comprises” or “comprising” encompass the notions of “including” and “having” and specify the presence of elements, operations, and/or groups or combinations thereof and do not imply preclusion of the presence or addition of one or more other elements, operations and/or groups or combinations thereof. Sequence of operations do not imply absoluteness unless specifically so stated. Reference to an element in the singular, such as by use of the article “a” or “an”, is not intended to mean “one and only one” unless specifically so stated, but rather “one or more”. As used herein, “and/or” means “and” or “or”, as well as “and” and “or.” As used herein, ranges and subranges mean all ranges including whole and/or fractional values therein and language which defines or modifies ranges and subranges, such as “at least,” “greater than,” “less than,” “no more than,” and the like, mean subranges and/or an upper or lower limit. All structural and functional equivalents to the elements of the various embodiments described throughout the disclosure that are known or later come to be known to those of ordinary skill in the relevant art are intended to be encompassed by the features described and claimed herein. Moreover, nothing disclosed herein is intended to be dedicated to the public regardless of whether such disclosure may ultimately explicitly be recited in the claims. No element or concept disclosed herein or hereafter presented shall be construed under the provisions of 35 USC 112(f) unless the element or concept is expressly recited using the phrase “means for” or “step for”.

In view of the many possible embodiments to which the disclosed principles can be applied, we reserve the right to claim any and all combinations of features and acts described herein, including the right to claim all that comes within the scope and spirit of the foregoing description, as well as the combinations recited, literally and equivalently, in the following claims and any claims presented anytime throughout prosecution of this application or any application claiming benefit of or priority from this application.

What is claimed is:

1. A coaxial cable connector, suitable for connecting to a connector with a threaded surface of an electronic device, the coaxial cable connector including:
an inner sleeve, surrounding an axial line and including a first surface and a second surface, an outer surface of the inner sleeve being stepladder-like;
a first outer sleeve, coaxially arranged outside the inner sleeve and including a head potion and an end portion, the head portion surrounding the first surface of the inner sleeve;
a nut, sleeved on the inner sleeve and including a threaded section and an inner flange, the threaded section connects to the threaded surface of the electronic device, an inclined surface of the inner flange is arranged angularly to the axial line; and
a second outer sleeve, sleeved on the end portion of the first outer sleeve, wherein an inner peripheral surface of the second outer sleeve presses against the end portion of the first outer sleeve and approaches the axial line as the second outer sleeve moves axially toward the nut.

2. The coaxial cable connector of claim 1, wherein the inner peripheral surface of the second outer sleeve has a guiding inclined surface, facing the end portion of the first outer sleeve.

3. The coaxial cable connector of claim 1, wherein an inner surface of the end portion of the first outer sleeve is rough.

4. The coaxial cable connector of claim 1, wherein an outer peripheral surface of a rearward extending section of the inner sleeve is parallel to the axial line, and an inner surface of the end portion of the first outer sleeve has a groove.

5. The coaxial cable connector of claim 1, further including a C-shaped ring being conductive and arranged between the second surface of the inner sleeve and the inclined surface of the inner flange.

6. The coaxial cable connector of claim 1, further including a spring being conductive and including a base and at least one elastic wing, the base connected to the second surface of the inner sleeve, the elastic wing is bent outward based on the base with an angle as the spring is in a relaxed state, the elastic wing is arranged between the inner flange and the inner sleeve radially as the elastic wing is in a compressed state.

7. The coaxial cable connector of claim 6, further including a C-shaped ring being conductive and arranged between the second surface of the inner sleeve and the inclined surface of the inner flange.

8. The coaxial cable connector of claim 7, wherein an upper-side width and a lower-side width of the C-shaped ring are equal cross-sectionally.

9. The coaxial cable connector of claim 6, wherein the elastic wing being against an inclined surface of the inner flange of the nut, the inclined surface is inclined from a radially extending surface of the inner flange to an axially extending surface of the inner flange.

10. The coaxial cable connector of claim 6, wherein a thickness of the elastic wing is ranging from 0.05 mm to 0.5 mm.

11. The coaxial cable connector of claim 6, wherein the base and the elastic wing are integrated.

12. The coaxial cable connector of claim 6, wherein the inner sleeve further includes an outer flange, the second surface of the inner sleeve is arranged between the outer flange and the first surface, the spring further includes a baffle portion and a connecting portion connecting to the baffle portion and the base, the spring is in a compressed state as the nut exactly connects to the connector of the electronic device, the baffle portion is arranged between the outer flange and the inner flange, and further the connecting portion is arranged between the inner flange and the inner sleeve radially.

13. The coaxial cable connector of claim 12, wherein the angle of the spring is an acute angle and faces to the baffle portion as the spring relaxed.

14. The coaxial cable connector of claim 12, wherein a thickness of the baffle portion is ranging from 0.05 mm to 0.5 mm.

15. A coaxial cable connector, suitable for connecting to a connector with a threaded surface of an electronic device, the coaxial cable connector including:
an inner sleeve, surrounding an axial line and including a first surface, a second surface and an inclined surface, an outer surface of the inner sleeve being stepladder-like, the inclined surface arranged angularly to the axial line;
a first outer sleeve, coaxially arranged outside the inner sleeve and including a head portion and an end portion, the head portion surrounding the first surface of the inner sleeve;
a nut, sleeved on the inner sleeve including a threaded section and an inner flange, the threaded section connecting to the threaded surface of the electronic device, the inner flange surrounding the second surface of the inner sleeve; and
a second outer sleeve, sleeved on the end portion of the first outer sleeve, wherein an inner peripheral surface of the second outer sleeve presses against the end portion of the first outer sleeve and approaches the axial line as the second outer sleeve moves axially toward the nut.

16. The coaxial cable connector of claim 15, wherein an outer peripheral surface of a rearward extending section of the inner sleeve is parallel to the axial line, and an inner surface of the end portion of the first outer sleeve has a groove.

17. The coaxial cable connector of claim 15, wherein an inner surface of the end portion of the first outer sleeve is rough.

18. The coaxial cable connector of claim 15, further including a C-shaped ring being conductive and surroundingly connected to the inclined surface of the inner sleeve, wherein the C-shaped ring is pushed via a radially extending surface of the inner flange to move along the inclined surface.

19. The coaxial cable connector of claim 18, wherein a cross-section shape of the conductive C-shaped ring can be selected from one of rectangle, circle, ellipse and polygon type.

20. The coaxial cable connector of claim 15, further including a spring including a base and at least one elastic wing, the base connected to the second surface of the inner sleeve, the elastic wing is further lying against the inclined surface of the inner sleeve.

21. A coaxial cable connector, suitable for connecting to a connector with a threaded surface of an electronic device, the coaxial cable connector including:
an inner sleeve, surrounding an axial line and including a first surface and a second surface, an outer surface of the inner sleeve being stepladder-like;
a first outer sleeve, coaxially arranged outside the inner sleeve and including a head potion and an end portion, the head portion surrounding the first surface of the inner sleeve, the end portion including an end surface perpendicular to the axial line and a groove on an inner surface thereof;
a nut, sleeved on the inner sleeve and including a threaded section and an inner flange, the threaded section connects to the threaded surface of the electronic device, an inclined surface of the inner flange is arranged angularly to the axial line;
a spring, being conductive and including a base and a single elastic wing, the base surrounding the part of the second surface of the inner sleeve, the single elastic wing being suitable for lying against the inclined surface of the nut; and
a second outer sleeve, sleeved on the end portion of the first outer sleeve, wherein an inner peripheral surface of the second outer sleeve presses against the end portion of the first outer sleeve and approaches the axial line as the second outer sleeve moves axially toward the nut.

22. The coaxial cable connector of claim 21, wherein the spring further includes a baffle porting and two connecting portions, the connecting portions connect the baffle portion and the base, the single elastic wing is located in the middle of the connecting portions, and the baffle portion is annular, when the spring is in a relaxed state, a first angle between the single elastic wing and the axial line is greater than a second angle between the inclined surface of the nut and the axial line.

23. The coaxial cable connector of claim 22, wherein the spring further includes a protrusion portion formed on the single elastic wing, the protrusion portion is used for contacting the inclined surface of the nut, and a thickness of the protrusion portion is ranging from 0.1 mm to 0.2 mm.

24. The coaxial cable connector of claim 23, wherein a shape of the protrusion portion of the spring can be selected from one of circle, rectangle, square, diamond, trapezoid, ellipse, cross and polygon.

25. The coaxial cable connector of claim 22, wherein the single elastic wing of the spring is in a bent shape, the single elastic wing has a first extension and a second extension, and a ridge is formed at the junction of the first extension and the second extension, the ridge is used for contacting the inclined surface of the nut.

26. The coaxial cable connector of claim 22, wherein the single elastic wing of the spring is in an arc shape.

27. The coaxial cable connector of claim 22, wherein the spring further includes a counterweight portion disposed on the baffle portion, and the counterweight portion is correspondingly disposed on an opposite side of the single elastic wing.

28. The coaxial cable connector of claim 27, wherein the counterweight portion of the spring is formed on the inner peripheral surface of the baffle portion and extends inward.

29. A coaxial cable connector, suitable for connecting to a connector with a threaded surface of an electronic device, the coaxial cable connector including:
an inner sleeve, surrounding an axial line and including a first surface, a second surface and an inclined surface, an outer surface of the inner sleeve being stepladder-like, the inclined surface arranged angularly to the axial line;
a first outer sleeve, coaxially arranged outside the inner sleeve and including a head portion and an end portion, the head portion surrounding the first surface of the inner sleeve, the end portion including an end surface perpendicular to the axial line and a groove on an inner surface thereof;
a nut, sleeved on the inner sleeve including a threaded section and an inner flange, the threaded section connecting to the threaded surface of the electronic device, the inner flange surrounding the second surface of the inner sleeve, the inner flange including an inclined surface arranged angularly to the axial line;
a spring, being conductive and including a base and a single elastic wing, the base being annular and surrounding the second surface of the inner sleeve, the single elastic wing being suitable for lying against the inclined surface of the inner sleeve; and
a second outer sleeve, sleeved on the end portion of the first outer sleeve, wherein an inner peripheral surface of the second outer sleeve presses against the end portion of the first outer sleeve and approaches the axial line as the second outer sleeve moves axially toward the nut.

30. The coaxial cable connector of claim 29, wherein the spring further includes a protrusion portion formed on the single elastic wing, the protrusion portion is used for contacting the inclined surface of the inner sleeve, and a thickness of the protrusion portion is ranging from 0.1 mm to 0.2 mm.

31. The coaxial cable connector of claim 29, wherein the single elastic wing of the spring is in a bent shape, the single elastic wing has a first extension and a second extension, and a ridge is formed at the junction of the first extension and the second extension, the ridge is used for contacting the inclined surface of the inner sleeve.

32. The coaxial cable connector of claim 29, wherein the single elastic wing of the spring is in an arc shape.
